(19) United States
(12) Patent Application Publication
(10) Pub. No.: US 2006/0006028 A1
(43) Pub. Date: Jan. 12, 2006

(54) Braking device for a spool of multiplying fisher reels

(76) Inventor: Vasily Afanasievich Pilipchuck, Reutovo (RU)

Correspondence Address: LADAS & PARRY, 26 WEST 61ST STREET, NEW YORK, NY, 10023, US

(21) Appl. No.: 10/523,956

(22) PCT Filed: Aug. 12, 2002
(86) PCT No.: PCT/RU02/00383

§ 371 Date: Feb. 8, 2005

(51) Int. Cl. B60T 1/16

(52) U.S. Cl. 188/270

(57) ABSTRACT

A braking device for a spool of multiplier fishing reels during a lure cast is described, which provides smooth variation of the braking effort, necessary when passing over to another lure without disassembling the reel. The device is based on the principle of creating an air flow with the aid of a member which is connected with the spool and is set in rotation simultaneously therewith, and of varying the resistance to this flow with the aid of movable chokes.

### FIELD OF THE ART

The present invention relates to fishing tackle, more particularly to multiplying fishing reels, and more specifically to devices for braking the spool of said reels when casting a lure.

### STATE OF THE ART

Multiplying fishing reels are widely used in fishing practice. Multiplying fishing reels belong to the type of inertial reels, i.e., they contain parts which move (rotate) during a cast. The main disadvantage of such reels is the possibility of the fishing line entanglement during a cast. This is accounted for by the following. At the initial moment of casting the lure has a speed V, and the spool of the reel has a rotary speed N (from 200 to 500 r.p.s.), the radial rotary speed of the spool being equal to the speed of the lure. The lure, while in flight, experiences the effect of an aerodynamic drag proportional to the square of the rate of movement.. As a result, the spool throws off the fishing line faster than the lure draws it out, and the fishing line becomes entangled. The so-called “wig” or “beard” is thus formed. In order to match the rates of movement of the spool and lure, the reel is provided with a spool braking device, including such wherein the braking force depends on the speed of rotation of the spool. Two types of such brakes, a centrifugal brake and a magnetic brake, are the most widespread.

A centrifugal brake comprises a plurality of small weights (from two to six), which during the spool rotation, under the action of the centrifugal force, are pressed to the internal surface of a cylinder and create a braking moment whose value depends quadratically on the speed of rotation of the spool.

The value of the braking effort must correspond to the weight of the lure being cast, this adding to the necessity of adjusting the braking effort when passing over to another lure.

The same (quadratic) character of variation of the braking force of the spool and of the rate of movement of the lure thus attained rules out or at least diminishes the probability of the fishing line entanglement and makes it possible to cast the lure over a greater distance.

In practice such adjustment is effected by coupling a definite number of weights, for which purpose most types of the reels have to be disassembled on the water body, this being very inconvenient. There exist reels in which such adjustment is performed without disassembling the reel, but such reels are expensive and therefore have not become widespread.

In addition to the above-said, the centrifugal brake suffers from the following disadvantages:

stepped adjustment of the braking force, which does not allow precise adjustment of the braking force when casting lures within a wide range of weights and of the aerodynamic drag offered to the lures during a cast.;

dependence of the braking force on the state of rubbing surfaces.

The ingress of water or a lubricant to these surfaces temporarily puts such brake out of operation, this involving the fishing line entanglement.

A magnetic brake usually comprises two magnets: a movable magnet secured on a spool and a stationary magnet. The braking force of the spool depending on the lure parameters is adjusted by varying the distance between the magnets. Magnetic brakes are usually used on so-called “bait-casting” reels intended for casting small-weight lures. As a rule, magnetic brakes are not used on medium reels, because for creating a considerable braking force it is necessary to increase the mass of the magnet, this leading to an increase of the spool inertiality. Furthermore, there is no quadratic dependence of the value of the braking force on the rotary speed of the spool, and therefore it cannot be adjusted optimally.

### ESSENCE OF THE INVENTION

One object of the present invention is to provide a fishing reel with a spool braking device free from the above-indicated disadvantages of centrifugal and magnetic brakes. More particularly, it is an object of the invention to provide a reel with a spool braking device which would make it possible to adjust the braking force depending on the weight of a lure and on external factors without disassembling the reel.

Another object of the invention is to provide a braking device for a spool of a fishing reel, which would ensure fine (not discrete) adjustment of the value of the braking effort.

Still another object of the invention is to provide a braking device for a spool of a fishing reel, whose operation would be not affected by the use environment.

Said objects are accomplished by the provision of a device in which a novel principle of spool braking is realized, which consists in securing adjustable resistance to an air flow created by a member driven in rotation as the spool rotates.

A braking device for a spool, according to the present invention, comprises a member driven in rotation as the spool rotates and creating while in rotation, an air flow, and a means for creating adjustable aerodynamic resistance to this air flow.

The member serving to create an air flow and means for creating adjustable aerodynamic resistance may have various structural embodiments, not going beyond the essence of the present invention.

As one of preferred embodiments of the member serving to create an air flow can be a vane or a plurality of vanes set in rotation as the spool rotates. The vanes of said plurality can be structurally combined with one another, for instance, by securing them on a common disk or on rods (spokes) secured on a common hub. Said vanes, when rotating, create an air flow oriented mainly perpendicular to the axis of rotation. Therefore in the subsequent description of the present invention the element of such construction will be termed “centrifugal impeller”.

Another possible variant of embodying the member creating an air flow is to make it as a screw. When rotating, this crew will create an air flow directed predominantly parallel to the axis of rotation of the screw.

The embodiment of the means for creating adjustable resistance to the air flow may also vary. A mandatory feature of all these means is the presence in the path of the air flow of a movable member which, when moving, changes the resistance offered by this element to the air flow, i.e., functions as a choke. This member can be disposed either at the entrance or exit of the air flow or in any point of the flow.

The air flow may move both in open channels, i.e., come from and return to the atmosphere, and in closed ducts made in the spool body or in the housing which encloses the braking device.

A mandatory condition for the functioning of the spool braking device according to the present invention is that the member creating an air flow must be set in rotation as the spool rotates, but this synchronous rotation can be provided in various ways. It is preferable that the spool and said member should be in rigid connection, in particular, by mounting said member on an axle common with the spool. However, a kinematical connection therebetween is also possible.

### EXEMPLARY EMBODIMENTS OF THE INVENTION

A detailed description of the invention is given hereinbelow with reference to the accompanying drawings, in which:

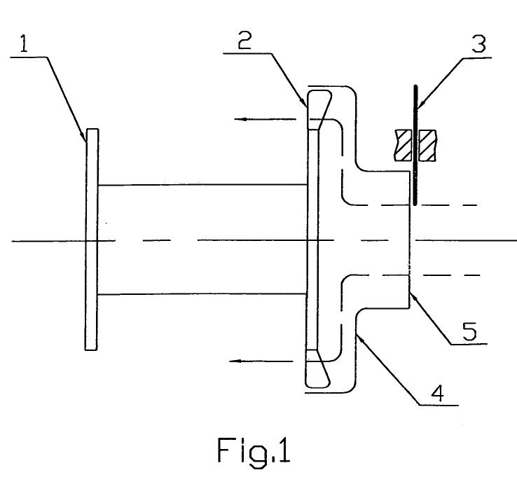

FIG. 1 illustrates the novel principle of spool braking, realized by the device according to the present invention;

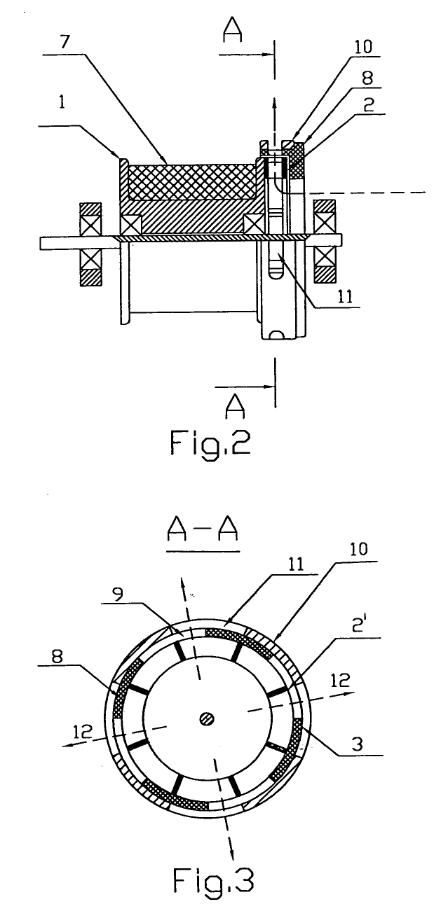

FIG. 2 shows a reel equipped with a spool braking device, according to one of possible variants of embodying the invention;

FIG. 3 shows a sectional view of FIG. 2, taken along the line A-A;

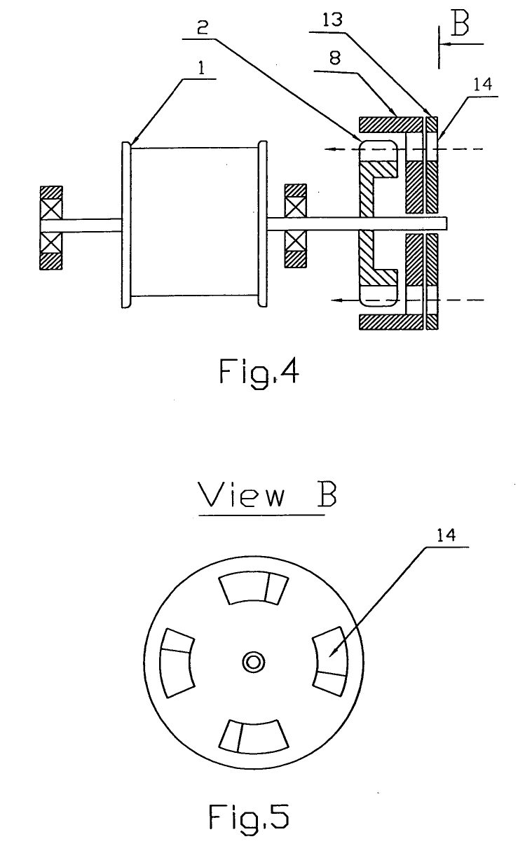

FIG. 4 shows a second variant of embodying the spool braking device;

FIG. 5 is a view of FIG. 4, taken along arrow B;

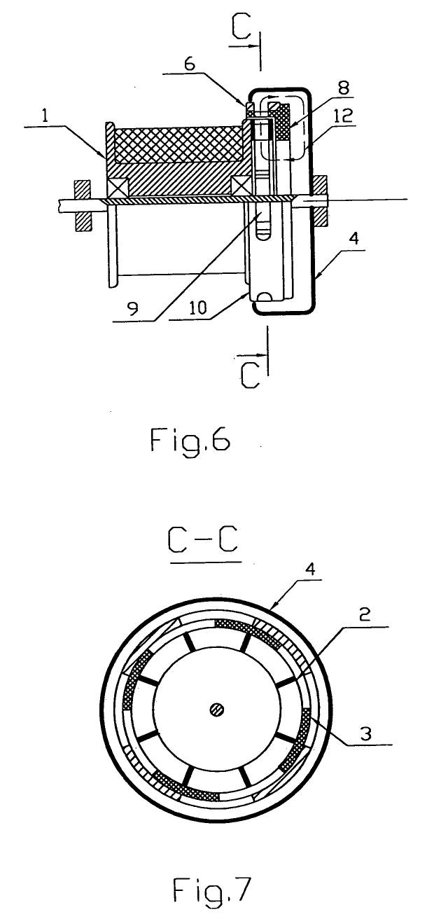

FIG. 6 shows a third variant of embodying the spool braking device;

FIG. 7 is a sectional view of FIG. 6, taken along the line C-C.

For understanding the general principle of functioning the spool braking device according to the present invention, let us consider FIG. 1 which shows diagrammatically a spool 1 and a member made in the form of vanes 2 for creating an air flow, attached to or connected with the spool, and a means for offering adjustable resistance to the air flow created by said member in the form of a choke 3. The air flow is indicated by arrows. A housing 4 with an air duct 5 coverable by the choke 3 are also shown diagrammatically in FIG. 1, but the presence of the housing is not mandatory in all the cases.

The device functions as follows. During the cast of a lure the spool 1 is set in rotation, and the vanes 2 are set in rotation too. An air flow created by said vanes, while passing along an air duct 5, encounters a resistance of different value, depending on the position of the choke 3. By varying the position of the choke (when passing over to another lure, when the aerodynamic resistance to the cast of a lure changes because of changes in the wind direction and force), the required change of the braking effort is achieved, this change (adjustment) being fine.

The variant of the spool braking device shown in FIGS. 2 and 3 is embodied as follows. The member 2 creating an air flow comprises a plurality of symmetrically arranged vanes 2′ fastened to the periphery of a disk 6 secured on a common shaft (axle) with the spool 1, a fishing line 7 being wound on the spool 1.

The disk 2 with the vanes 2′ (centrifugal impeller) is placed in a stationary cylindrical hollow member 8 with slots 9, around which (concentrically thereto) a ring 10 turnable relative to the spool axis and provided with slots 11 is disposed. By turning this ring different extent of opening of the slots 9 in the cylindrical hollow member is provided, owing to which a variation of the resistance to air flow 12 is ensured.

In the variant of the braking device, shown in FIGS. 4 and 5, slots in the cylindrical hollow member 8 are made not in its cylindrical surface as in the first variant, but in the end face surface, and instead of a turnable ring with slots use is made of a disk 13 with ports 14 in the end face surface thereof, turnable about the axis of the spool.

In both of the above-mentioned variants air is taken from the outside and ejected outwards by the member creating an air flow. However, a variant is possible, wherein an air flow circulates in a closed loop. This variant is shown in FIGS. 6 and 7.

As distinct from the first variant shown in FIGS. 2 and 3, this variant is characterized by the presence of the housing 4 which accommodates the impeller 6 and the cylindrical shell 8 with the slots 9 which surrounds the impeller 6, and the turnable ring 10 with the slots 11. The air flow 12 circulates inside the housing 4.

The above-described exemplary embodiments of the invention should not be regarded as limiting. Other modifications of the claimed invention, realizing the same spool braking principle which defines the essence and scope of the present invention may also be suggested.

1. A braking device for a spool of multiplying fishing reels, characterized in that it comprises:
member which is set in rotation as the spool rotates and which creates, when rotating, an air flow; and
means for creating an adjustable resistance offered to said air flow.

2. A braking device according to claim 1, characterized in that said member creating an air flow is made as an impeller, and said means for creating adjustable resis-tance to said flow comprise a movable choke installed in the path of said air flow.

3. A braking device according to claim 1, characterized in that said member creating an air flow is made as a screw.

4. A braking device according to claim 2, characterized in that the impeller is disposed in a cylindrical hollow member with slots for the passage of an air flow, and in that adjoining said cylindrical hollow member is the turnable member which closes, when turning, the slots in the cylindrical hollow member.

5. A braking device according to claim 4, characterized in that the slots are made in the cylindrical surface of the cylindrical hollow member, and the turnable member is made as a ring with ports, said ring being arranged concentrically with the cylindrical hollow member, outside the latter.

6. A braking device according to claim 4, characterized in that the slots are made in the end face surface of the cylindrical hollow member, and the turnable member is made as a disk with ports with ports, said disk adjoining said end face surface of the cylindrical hollow member.

7. A braking device according to claim 1, characterized in that it has an additional housing, and the air flow created by said member adapted to create an air flow circulates inside this housing.

8. A multiplying fishing reel, characterized in that it is fitted with a spool braking device made according to claim 1.
